(19) United States
(12) Patent Application Publication
(10) Pub. No.: US 2026/0093068 A1
(43) Pub. Date: Apr. 2, 2026

(54) END-CAPPED OPTICAL FIBER, FIBER ARRAY, LIGHT SOURCE DEVICE, AND WAVELENGTH BEAM COMBINING DEVICE

(71) Applicant: NICHIA CORPORATION, Anan-shi (JP)

(72) Inventors: Yoshio OKAMOTO, Yokohama-shi (JP); Norihiro DEJIMA, Yokohama-shi (JP)

(73) Assignee: NICHIA CORPORATION, Anan-shi (JP)

(21) Appl. No.: 19/331,138

(22) Filed: Sep. 17, 2025

(30) Foreign Application Priority Data
Sep. 30, 2024 (JP) 2024-171272
Apr. 21, 2025 (JP) 2025-069692

(51) Int. Cl. G02B 6/028; G02B 6/24; G02B 6/26; G02B 6/27; G02B 6/293

(52) U.S. Cl. CPC G02B 6/0288; G02B 6/241; G02B 6/262; G02B 6/2773; G02B 6/2931; G02B 6/29313

(57) ABSTRACT

An end-capped optical fiber includes: an optical fiber including a first portion comprising a first core and a first cladding surrounding the first core, and a second portion comprising a second core and a second cladding surrounding the second core; and an end cap comprising a first face connected to an end face of the second portion and a second face located on a side opposite the first face, wherein: a diameter of the first core is constant along an optical axis of the first core; a diameter of the second core gradually increases toward the end cap; the end cap includes a convex lens; the second surface includes a convex lens surface of the convex lens; and a focal point of the convex lens is located inside the optical fiber and away from the end face of the second portion.

### CROSS-REFERENCE TO RELATED APPLICATION

This application claims priority to Japanese Patent Application No. 2024-171272, filed on Sep. 30, 2024, and Japanese Patent Application No. 2025-069692, filed on Apr. 21, 2025, the disclosures of which are hereby incorporated by reference in their entireties.

### BACKGROUND

The present disclosure relates to an end-capped optical fiber, a fiber array, a light source device, and a wavelength beam combining device.

An end-capped optical fiber is an optical component that includes an optical fiber and an end cap fused to an end face of the optical fiber. The end cap may include a function as a collimating lens that collimates and emits light propagating through the optical fiber, depending on the application. Japanese Patent Publication No. 2021-507311 discloses an example of an end-capped optical fiber in which the end cap includes a collimating lens.

### SUMMARY

The present disclosure provides an end-capped optical fiber capable of reducing the divergence angle of a collimated light beam.

An end-capped optical fiber of the present disclosure in one embodiment includes: an optical fiber including a first portion having a first core and a first cladding surrounding the first core, and a second portion having a second core and a second cladding surrounding the second core, wherein the second core is adjacent to the first core and the second cladding is adjacent to the first cladding; and an end cap having a first face connected to an end face of the second portion and a second face located on opposite side of the first face, wherein: a diameter of the first core is constant along an optical axis of the first core; a diameter of the second core gradually increases toward the end cap; the end cap includes a convex lens; the second surface includes a convex lens surface of the convex lens; and a focal point of the convex lens is located inside the optical fiber and away from the end face of the second portion.

An end-capped optical fiber of the present disclosure in one embodiment includes: an optical fiber including a first portion having a first core and a first cladding surrounding the first core, and a second portion having a second core and a second cladding surrounding the second core, wherein the second core is adjacent to the first core and the second cladding is adjacent to the first cladding; and an end cap having a first face connected to an end face of the second portion and a second face located on opposite side of the first face, wherein: a diameter of the first core is constant along an optical axis of the first core; a diameter of the second core gradually increases toward the end cap; the end cap includes a convex lens; the second surface includes a convex lens surface of the convex lens; and a thickness of the end cap on an optical axis of the convex lens is less than a distance from an apex of the convex lens to a focal point of the convex lens.

A fiber array of the present disclosure in one embodiment includes: a plurality of end-capped optical fibers, each of which is the end-capped optical fiber set forth above, wherein: the second faces of the end caps of the plurality of end-capped optical fibers are facing the same side.

A light source device of the present disclosure in one embodiment includes: the fiber array set forth above, wherein the plurality of end-capped optical fibers include a first end-capped optical fiber and a second end-capped optical fiber; a first laser light source that emits a first laser beam, wherein the first laser beam couples to the optical fiber included in the first end-capped optical fiber from an opposite side of the end cap; and a second laser light source that emits a second laser beam, wherein the second laser beam couples to the optical fiber included in the second end-capped optical fiber from an opposite side of the end cap.

A wavelength beam combining device of the present disclosure in one embodiment includes: the light source device set forth above; and a diffraction grating, wherein: the first laser beam has a first peak wavelength; the second laser beam has a second peak wavelength shorter than the first peak wavelength; the first end-capped optical fiber emits a first light beam, obtained by collimating the first laser beam, from the second face of the end cap; the second end-capped optical fiber emits a second light beam, obtained by collimating the second laser beam, from the second face of the end cap; and the diffraction grating combines plurality of beams that include the first light beam and the second light beam.

According to an embodiment of the present disclosure, it is possible to realize an end-capped optical fiber capable of reducing the divergence angle of a collimated light beam.

### BRIEF DESCRIPTION OF THE DRAWINGS

FIG. 1A schematically shows a configuration of an end-capped optical fiber according to an exemplary embodiment of the present disclosure.

FIG. 1B schematically shows another configuration of an end-capped optical fiber according to an exemplary embodiment of the present disclosure.

FIG. 1C schematically shows yet another configuration of an end-capped optical fiber according to an exemplary embodiment of the present disclosure.

FIG. 1D schematically shows yet another configuration of an end-capped optical fiber according to an exemplary embodiment of the present disclosure.

FIG. 2A schematically shows a variation of an end-capped optical fiber according to an exemplary embodiment of the present disclosure.

FIG. 2B schematically shows another variation of an end-capped optical fiber according to an exemplary embodiment of the present disclosure.

FIG. 3A is a top view schematically showing a configuration of a fiber array according to an exemplary embodiment of the present disclosure.

FIG. 3B is a front view schematically showing a configuration of a fiber array according to an exemplary embodiment of the present disclosure.

FIG. 4A schematically shows a variation of a fiber array according to an exemplary embodiment of the present disclosure.

FIG. 4B schematically shows another variation of a fiber array according to an exemplary embodiment of the present disclosure.

FIG. 5 schematically shows a configuration of a light source device according to an exemplary embodiment of the present disclosure.

FIG. 6 schematically shows a configuration of a wavelength beam combining device according to an exemplary embodiment of the present disclosure.

FIG. 7A is a microscopic image of the end-capped optical fiber shown in FIG. 1C.

FIG. 7B is a graph showing how the radial size of the core and cladding in the optical fiber included in the end-capped optical fiber changes in the optical axis direction.

FIG. 8 is an example calculation showing the deviation, from the reference plane, of the focal position of a convex lens at which the divergence angle of the light beam is at minimum for the radius of curvature R.

FIG. 9 is an example calculation showing the deviation, from the reference plane, of the focal position of a convex lens at which the divergence angle of the light beam is at minimum for the spread angle θ.

FIG. 10A is a graph showing the relationship between the divergence angle of the light beam and the spread angle of the lateral surface of the second core when the focal position of a convex lens coincides with the reference plane.

FIG. 10B is a graph showing the relationship between the minimum value of the divergence angle of the light beam and the spread angle of the lateral surface of the second core in the example shown in FIG. 9.

FIG. 11A schematically shows an example of light rays propagating through an optical fiber in mode A.

FIG. 11B schematically shows an example of light rays propagating through an optical fiber in mode B.

FIG. 12A schematically shows an example of light rays propagating through an optical fiber in mode C.

FIG. 12B schematically shows an example of light rays propagating through an optical fiber in mode D.

### DETAILED DESCRIPTION

Referring now to figures, an end-capped optical fiber, a fiber array, a light source device, and a wavelength beam combining device according to embodiments of the present disclosure will be described. Parts with the same reference symbols or numerals in the figures denote the same or equivalent parts.

Furthermore, embodiments described below are examples to embody the technical concepts of the present invention, but the present invention is not intended to be limited to the described embodiments. The description of the size, material, shape, and relative arrangement of the components is not intended to limit the scope of the present invention thereto, but is intended to provide examples. The size and positional relationship of members shown in the figures may be exaggerated for ease of understanding.

### Embodiment

### End-Capped Optical Fiber

An end-capped optical fiber according to one embodiment of the present disclosure includes: an optical fiber including a first portion including a first core and a first cladding surrounding the first core, and a second portion having a second core and a second cladding surrounding the second core, wherein the second core is adjacent to the first core and the second cladding is adjacent to the first cladding; and an end cap (also referred to as “first end cap”) having a first face connected to an end face of the second portion and a second face located on opposite side of the first face, wherein: a diameter of the first core is constant along an optical axis of the first core; a diameter of the second core gradually increases toward the end cap; the end cap includes a convex lens; the second surface includes a convex lens surface of the convex lens; and a focal point of the convex lens is located inside the optical fiber and away from the end face of the second portion.

An end-capped optical fiber according to one embodiment of the present disclosure includes: an optical fiber including a first portion having a first core and a first cladding surrounding the first core, and a second portion having a second core and a second cladding surrounding the second core, wherein the second core is adjacent to the first core and the second cladding is adjacent to the first cladding; and an end cap (also referred to as “first end cap”) having a first face connected to an end face of the second portion and a second face located on opposite side of the first face, wherein: a diameter of the first core is constant along an optical axis of the first core; a diameter of the second core gradually increases toward the end cap; the end cap includes a convex lens; the second surface includes a convex lens surface of the convex lens; and a thickness of the end cap on an optical axis of the convex lens is less than a distance from an apex of the convex lens to a focal point of the convex lens.

The end-capped optical fiber configured as described above can reduce the divergence angle of the collimated light beam.

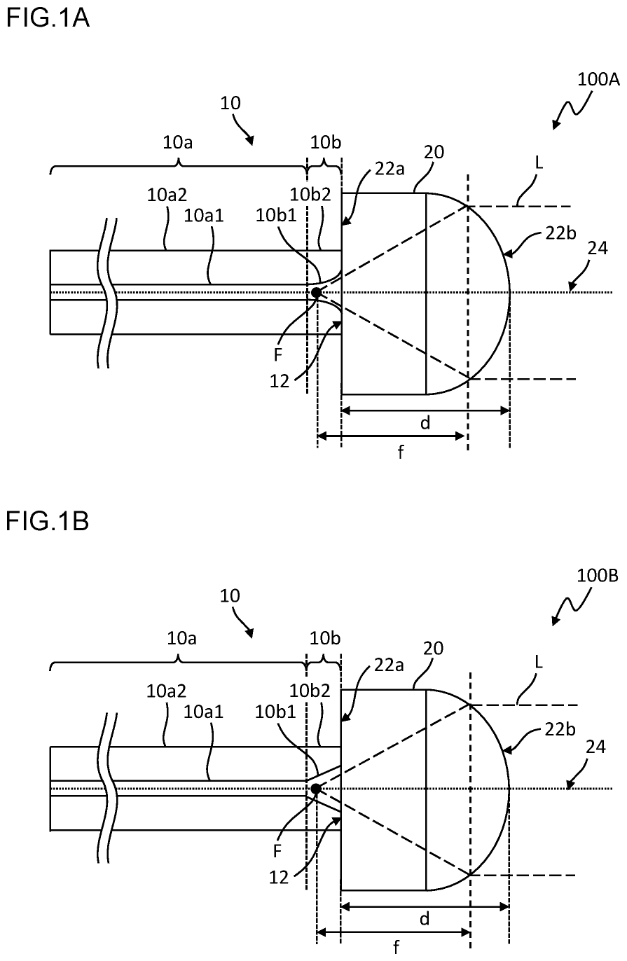

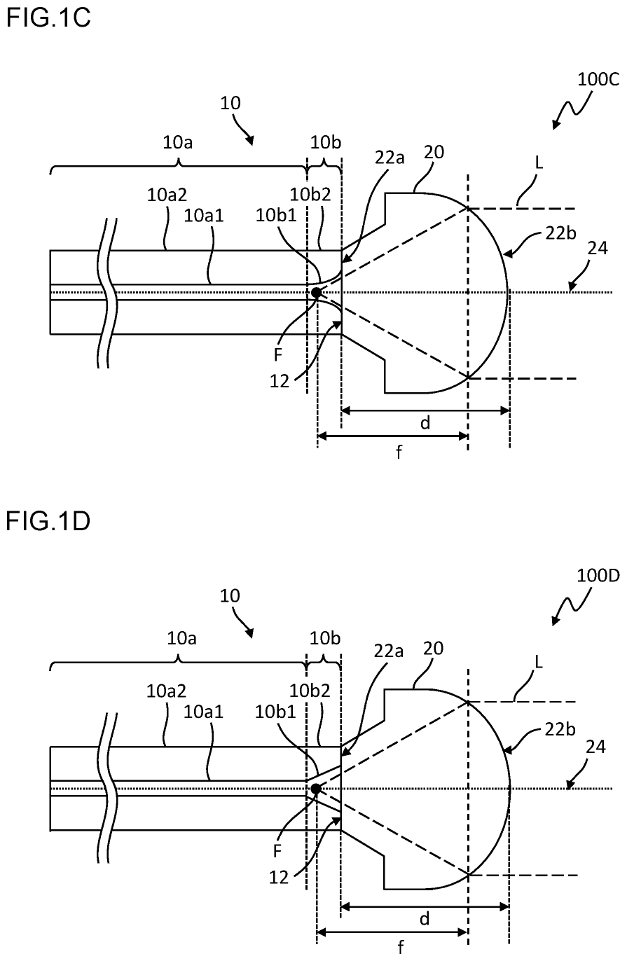

First, referring to FIG. 1A, an example configuration of an end-capped optical fiber according to an embodiment of the present disclosure will be described. FIG. 1A schematically shows a configuration of an end-capped optical fiber according to an exemplary embodiment of the present disclosure.

An end-capped optical fiber 100A shown in FIG. 1A includes an optical fiber 10 that propagates light, and an end cap 20 that is connected to the optical fiber 10 and emits the light propagating through the optical fiber 10 as a collimated light beam L. The optical fiber 10 and the end cap 20 are fused together. The light propagating through the optical fiber 10 may be laser light or LED light. The area enclosed by the broken line shown in FIG. 1A is an area where the intensity of the light beam L is equal to or greater than 1/e² of its highest intensity. e is the base of the natural logarithm. The optical fiber 10 may be, for example, a multi-mode fiber. Although the optical fiber 10 may be a single-mode fiber, a multi-mode fiber is advantageous in that it can propagate light with higher output power. The core of a multi-mode fiber may be formed, for example, from quartz, which is less susceptible to damage from high-power light.

The optical fiber 10 includes a first portion 10a and a second portion 10b to be described below. The first portion 10a has a first core 10a1 and a first cladding 10a2 surrounding the first core 10a1. Because the refractive index of the first core 10a1 is higher than the refractive index of the first cladding 10a2, the first core 10a1 can propagate light by total reflection at the boundary between the first core 10a1 and the first cladding 10a2. The second portion 10b has a second core 10b1 and a second cladding 10b2 surrounding the second core 10b1. Because the refractive index of the second core 10b1 is higher than the refractive index of the second cladding 10b2, the second core 10b1 can propagate light by total internal reflection at the interface between the second core 10b1 and the second cladding 10b2. The second core 10b1 is adjacent to the first core 10a1 and the second cladding 10b2 is adjacent to the first cladding 10a2. The refractive index of the second core 10b1 is the same as the refractive index of the first core 10a1, and the refractive index of the second cladding 10b2 is the same as the refractive index of the first cladding 10a2. As the optical fiber 10, an optical fiber having a double-clad structure may be used, in which the first cladding 10a2 and the second cladding 10b2 are surrounded by another cladding.

Before fusing the optical fiber 10 and the end cap 20, the diameter of the core of the optical fiber 10 is constant along the optical axis of the core. However, when the optical fiber 10 and the end cap 20 are fused together, the shape near an end face 12 of the optical fiber 10 is deformed and the diameter of the core of the optical fiber 10 is no longer constant along the optical axis of the core.

The differences between the first portion 10a and the second portion 10b deriving from the fusion are as follows. The diameter of the first core 10a1 is constant along the optical axis of the first core 10a1, whereas the diameter of the second core 10b1 gradually increases toward the end cap 20. The length of the second portion 10b on the optical axis of the second core 10b1 may be, for example, 0.01 mm or more and 0.5 mm or less. The end face 12 of the optical fiber 10 is also the end face 12 of the second portion 10b. In the example shown in FIG. 1A, the second core 10b1 spreads in a curved shape in a plane including the optical axis of the second core 10b1. The radius of curvature of the lateral surface of the second core 10b1 may be, for example, 0.01 mm or more. In the example shown in FIG. 1A, the shape of the spread of the second core 10b1 is symmetrical with respect to the optical axis of the second core 10b1. The length of the second portion 10b and the shape of the spread of the second core 10b1 depend on the fusion conditions, such as the heating temperature and the pressure when fusing the optical fiber 10 and the end cap 20.

The diameter of the second core 10b1 is not constant along the optical axis and gradually increases toward the end cap 20. Therefore, the pseudo light-emitting surface that emits the propagating light in the optical fiber 10 is not located at the end face 12 of the second portion 10b, but inside the second core 10b1 away from the end face 12 or at the boundary between the first core 10a1 and the second core 10b1. A case in which the pseudo light-emitting surface is located inside the second core 10b1 away from the end face 12, and a case in which the pseudo light-emitting surface is located at the boundary between the first core 10a1 and the second core 10b1 will be explained in the calculation examples below.

The end cap 20 includes a convex lens. The end cap 20 has a first face 22a that is connected to the end face 12 of the second portion 10b and a second face 22b that is located on the opposite side of the first face 22a and includes a convex lens surface of the convex lens. The dotted line shown in FIG. 1A represents the optical axis 24 of the convex lens. As shown in FIG. 1A, the optical axis of the first core 10a1, the optical axis of the second core 10b1, and the optical axis of the light beam L coincide with the optical axis 24 of the convex lens. Note, however, that some deviation between these optical axes is allowed as long as a collimated light beam is obtained. The positional deviation between optical axes may be, for example, 200 μm or less, preferably 50 μm or less. The angular deviation between optical axes may be, for example, 1.0° or less, preferably 0.2° or less.

If the refractive index of the end cap 20 is close to the refractive index of the second core 10b1 of the second portion 10b included in the optical fiber 10, it is possible to reduce the Fresnel reflection at the end face 12 of the second portion 10b. When their refractive indices are the same, the Fresnel reflection at the end face 12 of the second portion 10b does not occur.

The area of the first face 22a is larger than the area of the end face 12 of the second portion 10b. Therefore, it is easy to fuse the optical fiber 10 and the end cap 20 so that the end face 12 of the second portion 10b is located near the optical axis of the convex lens at the first face 22a. Fusion can be suitably performed, for example, by the laser fusion method described below. The minimum dimension of the first face 22a in the direction perpendicular to the optical axis of the convex lens may be, for example, 0.05 mm or more and 20 mm or less. The maximum dimension of the end face 12 of the second portion 10b in a direction perpendicular to the optical axis of the convex lens may be, for example, 0.05 mm or more and 2.0 mm or less.

The convex lens included in the end cap 20 has the focal point F. Light rays passing through the focal point F of the convex lens become parallel to the optical axis of the convex lens after passing through the convex lens. The focal point F of the convex lens is located inside the optical fiber 10 and away from the end face 12 of the second portion 10b. More specifically, the focal point F of the convex lens is located inside the second core 10b1 or at the boundary between the first core 10a1 and the second core 10b1. The back focus of the convex lens is greater than 0. The thickness d of the end cap 20 on the optical axis of the convex lens included in the end cap 20 is less than the distance from the apex to the focal point F of the convex lens. The apex of the convex lens is located at a position where the optical axis of the convex lens intersects the surface of the convex lens. The distance from the apex to the focal point F of the convex lens may be, for example, 0.5 mm or more and 100 mm or less. The distance from the apex to the focal point F of the convex lens is longer than the focal length f of the convex lens. Here, the focal length means the rear focal length.

In the configuration where the focal point F of the convex lens in the end cap 20 is located at the end face 12 of the second portion 10b, unlike the end-capped optical fiber 100A according to the present embodiment, the focal point F of the convex lens is away from the pseudo light-emitting surface in the optical fiber 10. Because of this, the laser light propagating through the optical fiber 10 is emitted from a second face 22b of the end cap 20 without being sufficiently collimated by the convex lens.

In contrast, in the end-capped optical fiber 100A according to the present embodiment, the focal point F of the convex lens is located inside the optical fiber 10 and away from the end face 12 of the second portion 10b. More specifically, the focal point F of the convex lens is located inside the second core 10b1 or at the boundary between the first core 10a1 and the second core 10b1. Therefore, the focal point F of the convex lens can be brought closer to the pseudo light-emitting surface in the optical fiber 10, and more preferably, the focal point F of the convex lens can be located on the pseudo light-emitting surface. As a result, the propagating light in the optical fiber 10 exits the second face 22b of the end cap 20 as the light beam L sufficiently collimated by the convex lens. In the present specification, “collimated light beam L” includes not only a light beam L that is perfectly collimated, but also a light beam L with reduced divergence. The divergence angle (total angle) of the sufficiently collimated light beam L can be, for example, 0.4° or less.

Thus, the end-capped optical fiber 100A according to the present embodiment can reduce the divergence angle of the collimated light beam L.

As a result of the misaligned fusion splicing between the optical fiber 10 and the end cap 20, the focal point F of the convex lens may be located inside the optical fiber 10 and away from the end face 12 of the second portion 10b, but not inside the second core 10b1 or at the boundary between the first core 10a1 and the second core 10b1. Even in that case, if the focal point F of the convex lens is closer to the pseudo light-emitting surface than when it is located at the end face 12, it is possible to reduce the divergence angle of the collimated light beam L.

In the example described above, the end-capped optical fiber 100A emits the propagating light in the optical fiber 10 as a collimated light beam L from the end cap 20, but is not limited to this example. The end-capped optical fiber 100A can take in the collimated light beam L through the second face 22b of the end cap 20 and have it propagate into the optical fiber 10. Where the light beam L is taken in through the second face 22b of the end cap 20, the term pseudo light-emitting surface can be read alternatively as pseudo light-receiving surface. Thus, the end-capped optical fiber 100A can effectively take in the collimated light beam L through the end cap 20.

FIG. 1B schematically shows another configuration of an end-capped optical fiber according to an exemplary embodiment of the present disclosure. An end-capped optical fiber 100B shown in FIG. 1B has a structure the same as or similar to the end-capped optical fiber 100A shown in FIG. 1A, except for the shape near the end of the optical fiber 10 to which the end cap 20 is fused.

In the example shown in FIG. 1B, the second core 10b1 spreads linearly in the plane including the optical axis of the second core 10b1. The spread angle (i.e., the half width at half maximum) of the lateral surface of the second core 10b1 with respect to the optical axis of the second core 10b1 may be, for example, 0.01° or more and 45° or less.

FIG. 1C schematically shows yet another configuration of an end-capped optical fiber according to an exemplary embodiment of the present disclosure. The end-capped optical fiber 100C shown in FIG. 1C differs from the end-capped optical fiber 100A shown in FIG. 1A in the following points. That is, the size of the first face 22a is smaller than the size of the second face 22b when viewed from the optical axis 24 side of the convex lens. This allows the size of the first face 22a to be closer to the size of the end face 12 of the second portion 10b of the optical fiber 10. Thus, it is easier to fuse the optical fiber 10 and the end cap 20 so that the optical axis of the optical fiber 10 and the optical axis of the convex lens are close or coincident. The size of the first face 22a may be, for example, 0.95 times or more and 1.5 times or less, or 0.95 times or more and 1.1 times or less, of the size of the end face 12.

FIG. 1D is a diagram schematically showing yet another configuration of an end-capped optical fiber according to an exemplary embodiment of the present disclosure. The end-capped optical fiber 100D shown in FIG. 1D has a structure similar to the end-capped optical fiber 100C shown in FIG. 1C, except for the shape near the end of the optical fiber 10 to which the end cap 20 is fused. In the example shown in FIG. 1D, as in the example shown in FIG. 1B, the second core 10b1 spreads linearly in the plane including the optical axis of the second core 10b1.

Next, a method of fusing the optical fiber 10 and the end cap 20 will be briefly described. The optical fiber 10 and the end cap 20 can be fused using, for example, a laser fusion method or an arc fusion method.

The laser fusion method can advantageously fuse two members with different diameters. With the laser fusion method, the connecting surface of the member with a larger diameter is irradiated with CO₂ laser to melt the connecting surface. The connecting surface of the member with a smaller diameter is pressed against the molten connecting surface, and the two members are fused together using the heat from the molten connecting surface. Because this method reduces melting of surfaces unrelated to the fusion, thereby reducing the deterioration of the members. The laser fusion method can be suitably used, for example, for the end-capped optical fibers 100A and 100B shown in FIG. 1A and FIG. 1B.

The arc discharge method can advantageously fuse two members that are close in diameter. With the arc discharge method, the connecting surfaces of the members are exposed to the plasma area generated by applying a voltage between two electrodes, thereby melting the connecting surfaces. By bringing the molten surfaces into contact with each other, the two members are fused together. The arc discharge method can be suitably used, for example, for the end-capped optical fibers 100C and 100D shown in FIG. 1C and FIG. 1D.

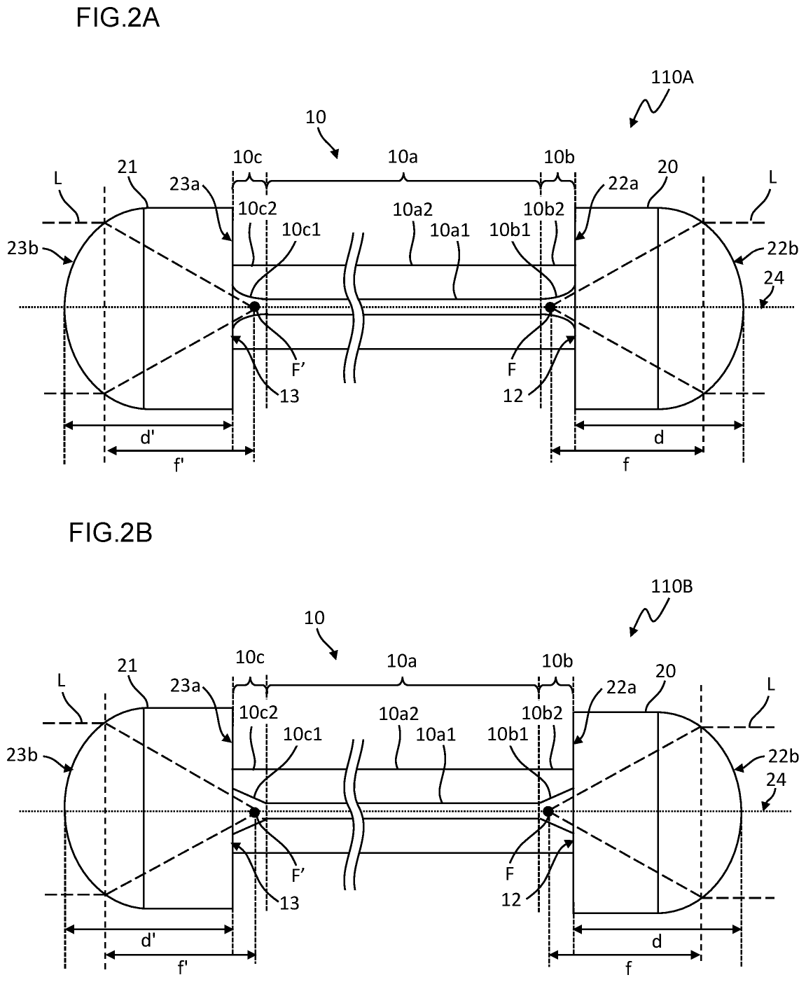

Next, referring to FIG. 2A, a variation of the end-capped optical fiber 100A according to the present embodiment will be described. FIG. 2A schematically shows a variation of the end-capped optical fiber 100A according to the present embodiment.

The end-capped optical fiber 110A shown in FIG. 2A differs from the end-capped optical fiber 100A shown in FIG. 1A in the following two points. The first point is that the end-capped optical fiber 110A further includes an end cap 21 that is connected to the optical fiber 10 on the opposite side of the end cap 20. The optical fiber 10 and the end cap 21 are fused. In the present specification, the end cap 21 is referred to also as the “second end cap.” The second point is that the optical fiber 10 further includes a third portion 10c that is located on the opposite side of the second portion 10b with respect to the first portion 10a.

The third portion 10c has a third core 10c1 and a third cladding 10c2 surrounding the third core 10c1. Because the refractive index of the third core 10c1 is higher than the refractive index of the third cladding 10c2, the third core 10c1 can propagate light by total reflection at the boundary between the third core 10c1 and the third cladding 10c2. The third core 10c1 is adjacent to the first core 10a1 , and the third cladding 10c2 is adjacent to the first cladding 10a2. The refractive index of the third core 10c1 is the same as the refractive index of the first core 10a1 , and the refractive index of the third cladding 10c2 is the same as the refractive index of the first cladding 10a2.

The differences between the first portion 10a and the third portion 10c deriving from the fusion between the optical fiber 10 and the end cap 21 are as follows. The diameter of the first core 10a1 is constant along the optical axis of the first core 10a1 , whereas the diameter of the third core 10c1 gradually increases toward the end cap 21. In the example shown in FIG. 2a, the third core 10c1 spreads in a curved shape in a plane including the optical axis of the third core 10c1. The radius of curvature of the lateral surface of the third core 10c1 may be, for example, 0.01 mm or more. In the example shown in FIG. 2A, the shape of the spread of the third core 10c1 is symmetrical with respect to the optical axis of the third core 10c1. In the example shown in FIG. 2A, the third core 10c1 may spread linearly.

The diameter of the third core 10c1 is not constant along the optical axis and gradually increases toward the end cap 21. Therefore, the pseudo light-emitting surface or the pseudo light-receiving surface in the optical fiber 10 is not located at an end face 13 of the third portion 10c, but inside the third core 10c1 away from the end face 13 or at the boundary between the first core 10a1 and the third core 10c1.

The end cap 21 includes a convex lens. In the present specification, the convex lens of the end cap 21 is referred to also as the “second convex lens.” The end cap 21 has a third face 23a connected to an end face 13 of the third portion 10c and a fourth face 23b that is located on the opposite side of the third face 23a and includes a convex lens surface of the convex lens. The area of the third face 23a is larger than the area of the end face 13 of the third portion 10c. Therefore, it is easy to fuse the optical fiber 10 and the end cap 21 so that an end face 13 of the third portion 10c is located near the optical axis of the convex lens at the third face 23a. The minimum dimension of the third face 23a in a direction perpendicular to the optical axis of the convex lens may be, for example, 0.05 mm or more and 20 mm or less. The maximum dimension of the end face 13 of the third portion 10c in a direction perpendicular to the optical axis of the convex lens may be, for example, 0.05 mm or more and 2.0 mm or less.

The convex lens included in the end cap 21 has the focal point F′. The focal point F′ of the convex lens included in the end cap 21 is located inside the optical fiber 10 and away from the end face 13 of the third portion 10c. More specifically, the focal point F′ of the convex lens is located inside the third core 10c1 or at the boundary between the first core 10a1 and the third core 10c1. The thickness d′ of the end cap 21 on the optical axis of the convex lens included in the end cap 21 is less than the distance from the apex to the focal point F′ of this convex lens. The distance from the apex to the focal point F′ of the convex lens may be, for example, 0.5 mm or more and 100 mm or less. The distance from the apex to the focal point F′ of the convex lens is longer than the focal length f′ of the convex lens.

In the end-capped optical fiber 110A, the focal point F′ of the convex lens is located inside the optical fiber 10 and away from the end face 13 of the third portion 10c, so that the focal point F′ of the convex lens can be brought closer to the pseudo light-emitting surface or the pseudo light-receiving surface in the optical fiber 10. More preferably, the focal point F′ of the convex lens can be positioned on the pseudo light-emitting surface or on the pseudo light-receiving surface. As a result, the light propagating through the optical fiber 10 is emitted from the fourth face 23b of the end cap 21 as a light beam L that is sufficiently collimated by the end cap 21. The divergence angle of the collimated light beam L is reduced.

Alternatively, the collimated light beam L is taken in through the fourth face 23b of the end cap 21 to propagate through the optical fiber 10. Therefore, with the end-capped optical fiber 110A, the collimated light beam L can be taken in through one of the end caps 20 and 21 and emitted through the other.

FIG. 2B schematically shows a variation of the end-capped optical fiber 100B according to the present embodiment. The end-capped optical fiber 110B shown in FIG. 2B differs from the end-capped optical fiber 100B shown in FIG. 1B in the two points described above for the end-capped optical fiber 110A shown in FIG. 2A. The end-capped optical fiber 110B shown in FIG. 2B has the same structure as the end-capped optical fiber 110A shown in FIG. 2A, except for the shape near the end of the optical fiber 10 to which the end caps 20 and 21 are fused.

In the example shown in FIG. 2B, as in the example shown in FIG. 1B, the second core 10b1 spreads linearly in the plane including the optical axis of the second core 10b1. In the example shown in FIG. 2B, the third core 10c1 further spreads linearly in the plane including the optical axis of the third core 10c1. The spread angle of the lateral surface of the third core 10c1 with respect to the optical axis of the third core 10c1 may be, for example, 0.01° or more and 45° or less. In the example shown in FIG. 2B, the third core 10c1 may spread in a curved shape.

Also for the end-capped optical fibers 110C and 110D shown in FIG. 1C and FIG. 1D, the same variations as those for the end-capped optical fibers 110A and 110B shown in FIG. 2A and FIG. 2B are possible.

### Fiber Array

A fiber array according to one embodiment of the present disclosure includes a plurality of end-capped optical fibers, each of which is an end-capped optical fiber set forth above, wherein the second faces of the end caps in the plurality of end-capped optical fibers are facing the same side.

The fiber array of the present disclosure, configured as described above, allows light to be input into a plurality of end-capped optical fibers to emit a plurality of collimated light beams from the plurality of end-capped optical fibers.

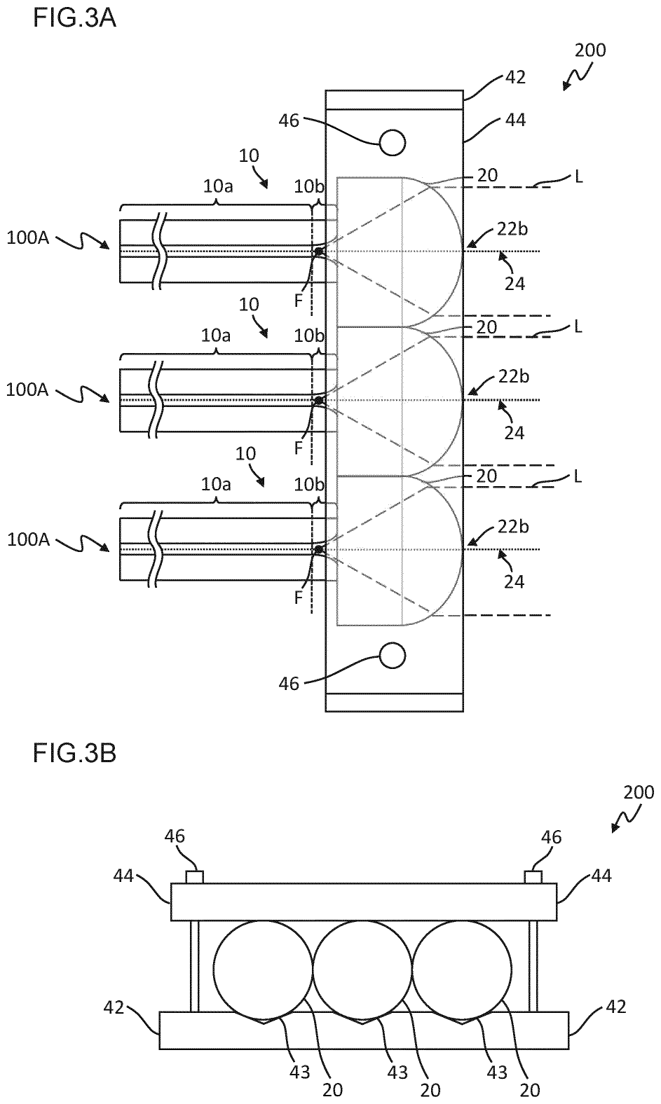

Referring to FIG. 3A and FIG. 3B, an example configuration of a fiber array according to an embodiment of the present disclosure will now be described. FIG. 3A and FIG. 3B are a top view and a front view, respectively, schematically illustrating a configuration of a fiber array according to an exemplary embodiment of the present disclosure.

A fiber array 200 shown in FIG. 3A and FIG. 3B includes a plurality of end-capped optical fibers 100A. The end-capped optical fiber 100B, 100C, or 100D may be used, instead of the end-capped optical fiber 100A.

The number of end-capped optical fibers 100A is three in the example shown in FIG. 3A and FIG. 3B, but the number is not limited to this example. The number of the end-capped optical fibers 100A may be two or four or more.

The fiber array 200 further includes a support member 42 that supports a plurality of end caps 20, a securing member 44 that secures the plurality of end caps 20, and screws 46 that keep the interval between the securing member 44 and the support member 42. As shown in FIG. 3B, the support member 42 has a plurality of recesses 43 for stably arranging the plurality of end caps 20. Each recess 43 corresponds to one end cap 20. The recesses 43 may be, for example, V-shaped grooves. FIG. 3A transparently shows the plurality of end caps 20 located under the securing member 44.

The second faces 22b of the end caps 20 in the plurality of end-capped optical fibers 100A are facing the same side. More specifically, the angle formed between the normal directions of the second faces 22b of the end caps 20 in any two of the plurality of end-capped optical fibers 100A is 45° or less. Preferably, the angle formed between the normal directions of the second faces 22b of the end caps 20 in any two end-capped optical fibers 100A is 5° or less. The normal direction of the second face 22b is the direction overlapping the optical axis of the convex lens included in the end cap 20 and away from the end cap 20.

In view of the above, the fiber array 200 according to the present embodiment can input light into a plurality of end-capped optical fibers 100A to emit a plurality of collimated light beams L from the plurality of end-capped optical fibers 100A. The wavelengths of the light input into the plurality of end-capped optical fibers 100A may all be the same, or some or all of them may be different.

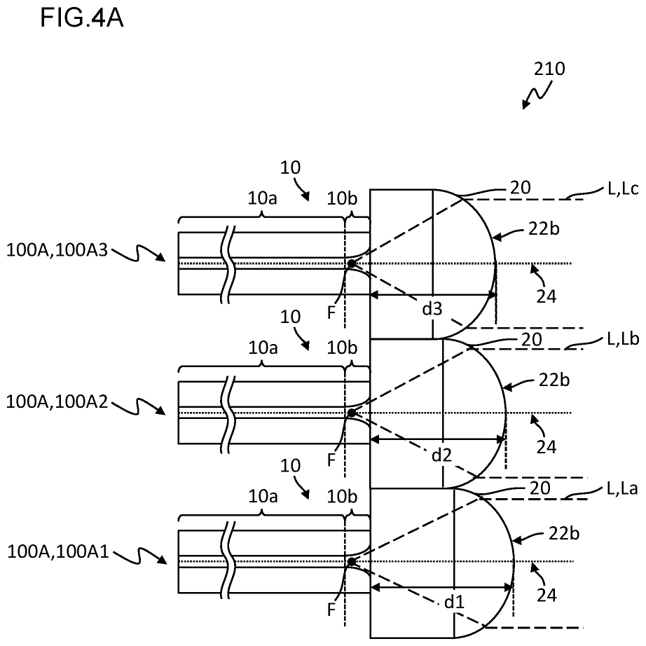

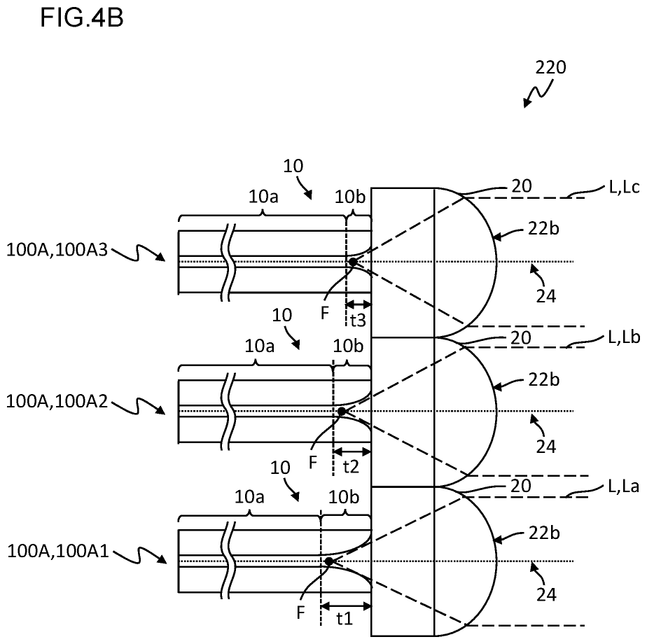

Next, referring to FIG. 4A and FIG. 4B, a variation of the fiber array 200 according to the present embodiment will be described. With the fiber array 200 according to the present embodiment, the plurality of end-capped optical fibers 100A all have the same structure. Where the wavelengths of light input to the plurality of end-capped optical fibers 100A are different, the plurality of end-capped optical fibers 100A may have different structures depending on the wavelength of the input light. The end-capped optical fiber 100B, 100C, or 100D may be used, instead of the end-capped optical fiber 100A.

FIG. 4A schematically shows Variation 1 of the fiber array 200 according to the present embodiment. In FIG. 4A, the support member 42, the securing member 44, and the screws 46 are not shown in the figure. The fiber array 210 shown in FIG. 4A differs from the fiber array 200 shown in FIG. 3A in the following points. The plurality of end-capped optical fibers 100A include an end-capped optical fiber 100A1 for a first wavelength λ1 (i.e., first end-capped optical fiber 100A1), an end-capped optical fiber 100A2 for a second wavelength λ2 shorter than the first wavelength λ1 (i.e., second end capped optical fiber 100A2), and an end-capped optical fiber 100A3 for a third wavelength λ3 shorter than the second wavelength λ2 (i.e., third end-capped optical fiber 100A3).

The shorter the wavelength of light propagating through the optical fiber 10, the higher the refractive index of the end cap 20 and thus the greater the optical path length. Based on this, in the end-capped optical fibers 100A1 to 100A3, the second portions 10b of the optical fibers 10 all have the same length, whereas the thicknesses d1 to d3 of the end caps 20 on the optical axis of the convex lens are all different. The shapes of the convex lenses are all the same, and the shapes near the end faces of the optical fibers 10 are all the same. Thus, the optical path lengths can be made equal.

More specifically, the thickness d2 on the optical axis of the convex lens of the end cap 20 included in the second end-capped optical fiber 100A2 is less than the thickness d1 on the optical axis of the convex lens of the end cap 20 included in the first end-capped optical fiber 100A1 . The thickness d3 on the optical axis of the convex lens of the end cap 20 included in the third end-capped optical fiber 100A3 is less than the thickness d2 on the optical axis of the convex lens of the end cap 20 included in the second end-capped optical fiber 100A2. That is, d1>d2>d3.

In view of the above, the end-capped optical fibers 100A1 to 100A3 included in the fiber array 210 can reduce the divergence angle of collimated light beams La to Lc of wavelengths λ1 to λ3, respectively.

FIG. 4B schematically shows Variation 2 of the fiber array 200 according to the present embodiment. A fiber array 220 shown in FIG. 4B differs from the fiber array 210 shown in FIG. 4A in the following points. That is, for the end-capped optical fibers 100A1 to 100A3, the thicknesses of the end caps 20 on the optical axis of the convex lens are all the same, whereas the lengths t1 to t3 of the second portions 10b in the optical fibers 10 are all different. The shapes of the convex lenses are all the same.

More specifically, the length t2 of the second portion 10b of the optical fiber 10 included in the second end-capped optical fiber 100A2 is less than the length t1 of the second portion 10b of the optical fiber 10 included in the first end-capped optical fiber 100A1 . The length t3 of the second portion 10b of the optical fiber 10 included in the third end-capped optical fiber 100A3 is less than the length t2 of the second portion 10b of the optical fiber 10 included in the second end-capped optical fiber 100A2. That is, t1>t2>t3.

In view of the above, the end-capped optical fibers 100A1 to 100A3 included in a fiber array 220 can reduce the divergence angle of collimated light beams La to Lc of wavelengths λ1 to λ3, respectively.

The fiber array 210 of Variation 1 and a fiber array 220 of Variation 2 can be suitably used when the difference between the longest wavelength and the shortest wavelength of the light coupled thereto is 0.1 nm or more and 50 nm or less. By adjusting the thickness of the end cap 20 of the convex lens on the optical axis or the length of the second portion 10b on the optical axis in consideration of the wavelength dependency of the convex lens, it is possible to effectively reduce the chromatic aberration of the end-capped optical fibers 100A1 to 100A3.

### Light Source Device

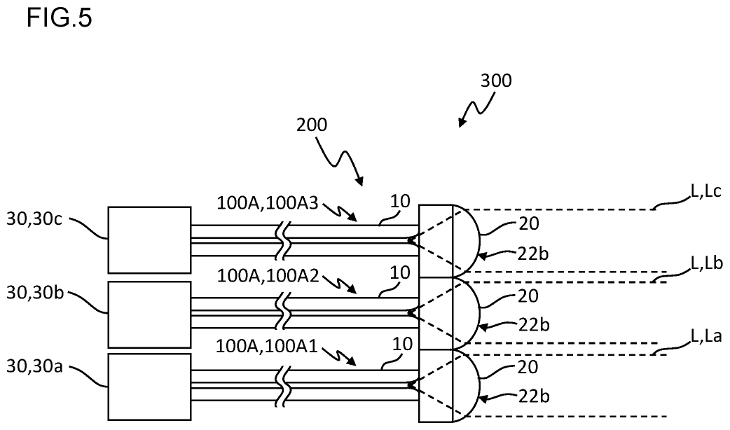

Next, referring to FIG. 5, an example configuration of a light source device according to an embodiment of the present disclosure will be described. FIG. 5 schematically shows a configuration of a light source device according to an exemplary embodiment of the present disclosure. A light source device 300 shown in FIG. 5 includes a plurality of laser light sources 30 and the fiber array 200 having a plurality of end-capped optical fibers 100A. Each end-capped optical fiber 100A corresponds to one laser light source 30. In FIG. 5, the support member 42, the securing member 44, and the screws 46 included in the fiber array 200 are not shown in the figure.

In the example shown in FIG. 5, the number of laser light sources 30 is three, but is not limited to this example. The number of laser light sources 30 may be two or three or more. The number of end-capped optical fibers 100A is the same as the number of laser light sources 30.

The laser light emitted from each laser light source 30 is coupled to the optical fiber 10 included in the corresponding end-capped optical fiber from the opposite side of the end cap 20. As a result, each end-capped optical fiber 100A emits a collimated laser beam L from the second face 22b of the end cap 20.

The peak wavelengths of the laser beams emitted from the plurality of laser light sources 30 may all be the same, or some or all of them may be different. The optical fiber 10 and the end cap 20 in each end-capped optical fiber 100A are appropriately designed according to the peak wavelength of the laser light emitted from the corresponding laser light source 30.

The plurality of laser light sources 30 includes a first laser light source 30a that emits a first laser beam at a first peak wavelength, a second laser light source 30b that emits a second laser beam at a second peak wavelength, and a third laser light source 30c that emits a third laser beam at a third peak wavelength. These three peak wavelengths may be, for example, 200 nm or more and 1100 nm or less, preferably 240 nm or more and 700 nm or less, and more preferably 360 nm or more and 570 nm or less.

When the first peak wavelength, the second peak wavelength, and the third peak wavelength are the first wavelength λ1, the second wavelength λ2, and the third wavelength λ3, respectively, the second peak wavelength is shorter than the first peak wavelength, and the third peak wavelength is shorter than the second peak wavelength. In that case, in the light source device 300, the fiber array 210 shown in FIG. 4A or the fiber array 220 shown in FIG. 4B may be used, instead of the fiber array 200.

The first laser beam couples to the optical fiber 10 included in the first end-capped optical fiber 100A1 from the opposite side of the end cap 20. The second laser beam couples to the optical fiber 10 included in the second end-capped optical fiber 100A2 from the side opposite the end cap 20. The third laser beam couples to the optical fiber 10 included in the third end-capped optical fiber 100A3 from the opposite side to the end cap 20.

The first end-capped optical fiber 100A1 emits a first light beam La, obtained by collimating the first laser beam, from the second face 22b of the end cap 20. The second end-capped optical fiber 100A2 emits a second light beam Lb, obtained by collimating the second laser beam, from the second face 22b of the end cap 20. The third end-capped optical fiber 100A3 emits a third light beam Lc, obtained by collimating the third laser beam, from the second face 22b of the end cap 20.

In view of the above, the light source device 300 according to the present embodiment can emit a plurality of collimated light beams L from the plurality of laser light sources 30 via the fiber array 200.

### Wavelength Beam Combining Device

A wavelength beam combining device of one embodiment according to the present disclosure includes: the light source device set forth above; and a diffraction grating, wherein: the first laser beam has a first peak wavelength; the second laser beam has a second peak wavelength shorter than the first peak wavelength; the first end-capped optical fiber emits a first light beam, obtained by collimating the first laser beam, from the second face of the end cap; the second end-capped optical fiber emits a second light beam, obtained by collimating the second laser beam, from the second face of the end cap; and the diffraction grating combines plurality of beams that include that include the first light beam and the second light beam.

In the wavelength beam combining device of the present disclosure configured as described above, the first light beam and the second light beam emitted from the light source device are combined by a diffraction grating to form a high-power combined beam.

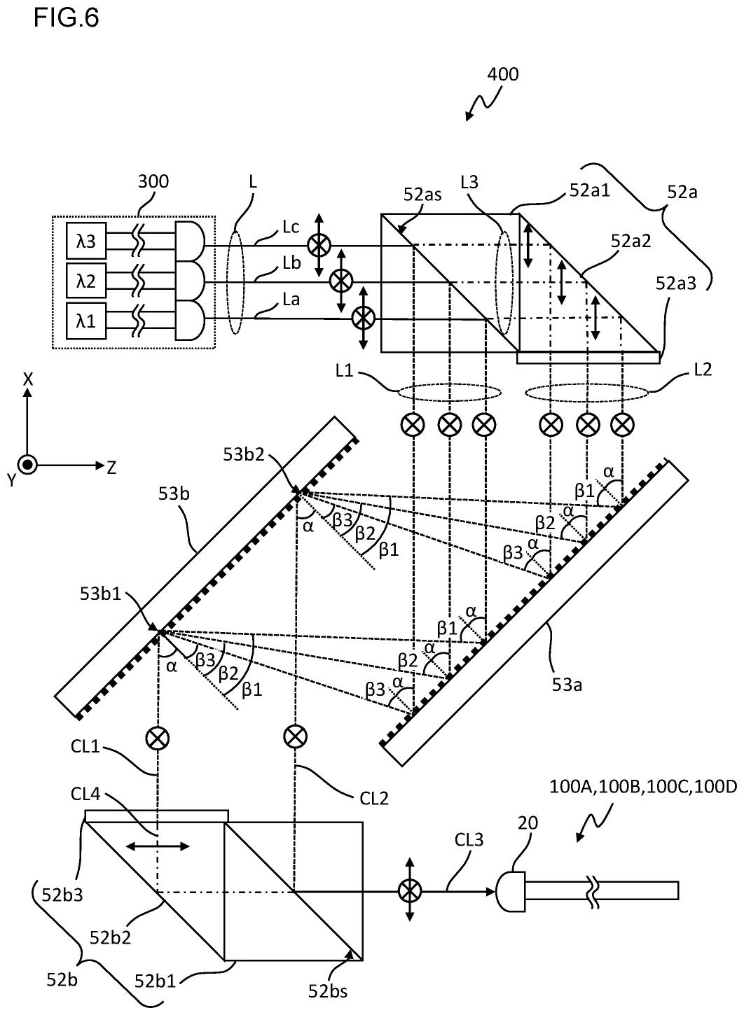

Next, referring to FIG. 6, an example configuration of a wavelength beam combining device according to an embodiment of the present disclosure will be described. The wavelength beam combining device includes a light source device 300 that emits a plurality of light beams L whose peak wavelengths differ from each other, and a diffraction grating. The diffraction grating combines the plurality of light beams L, including at least a first light beam La with a first peak wavelength and a second light beam Lb with a second peak wavelength shorter than the first peak wavelength. As a result, a high-power combined beam is formed.

FIG. 6 schematically shows a configuration of a wavelength beam combining device according to an exemplary embodiment of the present disclosure. The wavelength beam combining device 400 shown in FIG. 6 includes a light source device 300 that emits a plurality of unpolarized light beams L whose peak wavelengths differ from each other, a first optical member 52a, a second optical member 52b, a first diffraction grating 53a, a second diffraction grating 53b, an end-capped optical fiber 100A, 100B, 100C, or 100D. The first optical member 52a and the second optical member 52b have the same structure. The first diffraction grating 53a and the second diffraction grating 53b have the same structure and are arranged parallel to each other.

FIG. 6 schematically shows the X axis, the Y axis, and the Z axis orthogonal to each other for reference. The direction of the arrow on the X axis is referred to as the +X direction and the opposite direction as the-X direction. Where the +X direction and the-X direction are not distinguished from each other, the directions will be referred to simply as the X direction. This also applies to the Y direction and the Z direction. This does not limit the orientation of the wavelength beam combining device 400 in use, and the orientation of the wavelength beam combining device 400 is arbitrary.

The unpolarized light beam L includes a first light beam La of the first peak wavelength, a second light beam Lb of the second peak wavelength, and a third light beam Lc of the third peak wavelength. The first peak wavelength, the second peak wavelength, and the third peak wavelength are the first wavelength λ1, the second wavelength λ2, and the third wavelength λ3, respectively. That is, λ1>λ2>λ3.

The first optical member 52a includes a cube-shaped first polarization beam splitter 52a1 having a first polarization plane 52as, a first prism 52a2, and a first polarization conversion element 52a3 which is a ½ wave plate. The second optical member 52b includes a cube-shaped second polarization beam splitter 52b1 having a second polarization plane 52bs, a second prism 52b2, and a second polarization conversion element 52b3 which is a ½ wave plate.

In the example shown in FIG. 6, the first polarization beam splitter 52a1 and the first prism 52a2 are in contact, and the first prism 52a2 and the first polarization conversion element 52a3 are in contact, but it is not limited to this example. The first polarization beam splitter 52a1 and the first prism 52a2 may be apart from each other, and the first prism 52a2 and the first polarization conversion element 52a3 may be apart from each other. This also applies to the second polarization beam splitter 52b1 and the second prism 52b2, and the second prism 52b2 and the second polarization conversion element 52b3.

The double-sided arrow sign shown in FIG. 6 represents so-called P-polarized light, where the polarization direction is parallel to the XZ plane, and the sign of a cross symbol encircled by a small circle shown in FIG. 6 represents so-called S-polarized light, where the polarization direction is parallel to the Y direction. The solid line shown in FIG. 6 represents the unpolarized state, the broken line represents the S-polarized state, and the one-dot chain line represents the P-polarized state.

The first optical member 52a extracts, from the plurality of unpolarized light beams L traveling in the +Z direction, a plurality of collimated first polarized (S-polarized) beams L1 traveling in the-X direction and a plurality of collimated second polarized (S-polarized) beams L2 traveling in the-X direction, as follows. The reason for extracting a plurality of first polarized (S-polarized) beams L1 and second polarized (S-polarized) beams L2 from the plurality of unpolarized light beams L is that the diffraction efficiency of S-polarized light is higher than the diffraction efficiency of P-polarized light on the first diffraction grating 53a and the second diffraction grating 53b.

In the first optical member 52a, the first polarization beam splitter 52a1 splits a plurality of unpolarized light beams L traveling in the +Z direction by the first polarization plane 52as into a plurality of first polarized (S-polarized) beams L1 traveling in the-X direction and a plurality of collimated third polarized (P-polarized) beams L3 traveling in the +Z direction. The first prism 52a2 totally reflects, in the-X direction, the plurality of third polarization (P-polarized) beams L3 traveling in the +Z direction. The first polarization conversion element 52a3 converts the plurality of third polarized (P-polarized) beams L3 into a plurality of second (S-polarized) beams L2.

The first diffraction grating 53a is arranged such that the plurality of first polarization beams L1 and the plurality of second polarization beams L2 both enter at an angle of incidence of α (e.g., 45 degrees). Further, the first diffraction grating 53a is arranged so that the plurality of first polarization beams L1 incident parallel at the same angle of incidence α are diffracted at different diffraction angles β1 to β3 depending on the respective wavelengths λ1 to λ3 and are incident on a first region 53b1 of the facing second diffraction grating 53b. Further, the first diffraction grating 53a is arranged so that the plurality of second polarization beams L2 incident parallel at the same incident angle α are diffracted at different diffraction angles β1 to β3 depending on the respective wavelengths λ1 to λ3 and are incident on a second region 53b2 of the facing second diffraction grating 53b. The diffraction angle β2 corresponding to the wavelength λ2 is smaller than the diffraction angle β1 corresponding to the wavelength λ1, and the diffraction angle β3 corresponding to the wavelength λ3 is smaller than the diffraction angle β2 corresponding to the wavelength λ2. That is, β1>β2>β3.

The second diffraction grating 53b having the same structure as the first diffraction grating 53a is arranged so as to direct the reflected diffracted light from the first diffraction grating 53a, which is incident at different incident angles β1 to β3 depending on the wavelengths λ1 to λ3, at the same diffraction angle α (e.g., 45 degrees). As a result of wavelength beam combining and coaxially-coupling the plurality of first polarization beams L1, the first region 53b1 directs a collimated first combined beam CL1 of S-polarized light traveling in the-X direction. Similarly, as a result of wavelength beam combining and coaxially-coupling the plurality of second polarization beams L2, the second region 53b2 directs a collimated second combined beam CL2 of S-polarized light traveling in the-X direction.

The second optical member 52b forms a collimated third combined beam CL3 of unpolarized light traveling in the +Z direction from the first combined beam CL1 of S-polarized light traveling in the-X direction and the second combined beam CL2 of S-polarized light traveling in the-X direction, as follows. In the second optical member 52b, the second polarization conversion element 52b3 converts the first combined beam CL1 of S-polarized light into the collimated fourth combined beam CL4 of P-polarized light. The second prism 52b2 totally reflects, in the +Z direction, the fourth combined beam CL4 traveling in the-X direction. The second polarization beam splitter 52b1 combines the second combined beam CL2 traveling in the-X direction and the fourth combined beam CL4 traveling in the +Z direction by the second polarization plane 52bs to form the unpolarized third combined beam L3 traveling in the +Z direction.

The end-capped optical fiber 100A, 100B, 100C, or 100D effectively takes in the unpolarized collimated third combined beam L3. The optical axis of the third combined beam L3 is parallel to the optical axis of the convex lens included in the end cap 20. Further, from the end-capped optical fiber 100A, 100B, 100C, or 100D, the unpolarized third combined beam L3, that has been taken therein, exits the outside of the wavelength beam combining device 400.

As described above, with the wavelength beam combining device 400 of the present embodiment, a plurality of collimated unpolarized light beams L with different peak wavelengths are emitted from the light source device 300, and the plurality of light beams L are combined passing through the first optical member 52a, the first diffraction grating 53a, the second diffraction grating 53b, and the second optical member 52b in this order. As a result, the unpolarized collimated high-power third combined beam CL3 can be formed. The more the number of light beams L, the higher the output of the third combined beam CL3. The unpolarized collimated third combined beam CL3 is effectively taken in by the end-capped optical fiber 100A, 100B, 100C, or 100D, and exits the outside of the wavelength beam combining device 400.

### Example

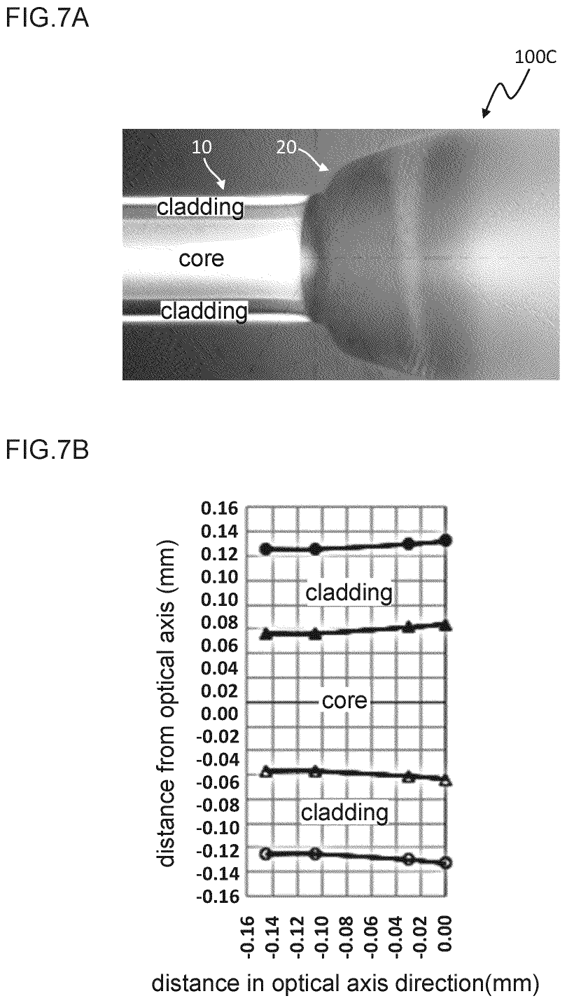

Referring to FIG. 7A and FIG. 7B, an example of the end-capped optical fiber 100C according to the present embodiment will be described. FIG. 7A is a microscopic image of the end-capped optical fiber 100C shown in FIG. 1C. FIG. 7B is a graph showing how the radial size of the core and cladding in the optical fiber 10 included in the end-capped optical fiber 100C changes in the optical axis direction. The vertical axis of the graph shown in FIG. 7B represents the distance of the core from the optical axis. The minus sign in front of a number on the vertical axis of the graph indicates that the distance is measured downward from the optical axis. The horizontal axis of the graph represents the distance of the core in the direction of the optical axis. A zero value on the horizontal axis means the position of the end face of the optical fiber 10 to which the end cap 20 is fused. A negative value on the horizontal axis means a position inside the optical fiber 10. The larger the absolute value of “distance” indicating a position of interest, the further the position is away from the end face of the optical fiber 10 toward the inside of the optical fiber 10.

The black triangles and the white triangles shown in FIG. 7B represent the distance (radius) from the optical axis to the upper and lower lateral surfaces, respectively, of the core in the plane including the optical axis of the core shown in FIG. 7A. The black circles and the white circles shown in FIG. 7B represent the distances (radius) from the optical axis to the upper and lower lateral surfaces, respectively, of the cladding in the same plane.

As shown in FIG. 7B, when the distance from the end face of the optical fiber 10 is greater than 0.10 mm, the diameter of the core is constant. In contrast, when the distance from the end face of the optical fiber 10 is 0.10 mm or less, the diameter of the core gradually increases toward the end cap 20. Therefore, the portion of the optical fiber 10 whose distance is farther away from the end face than 0.10 mm corresponds to the first portion 10a shown in FIG. 1C, and the portion whose distance from the end face is 0.10 mm or less corresponds to the second portion 10b shown in FIG. 1C.

### Example Calculation

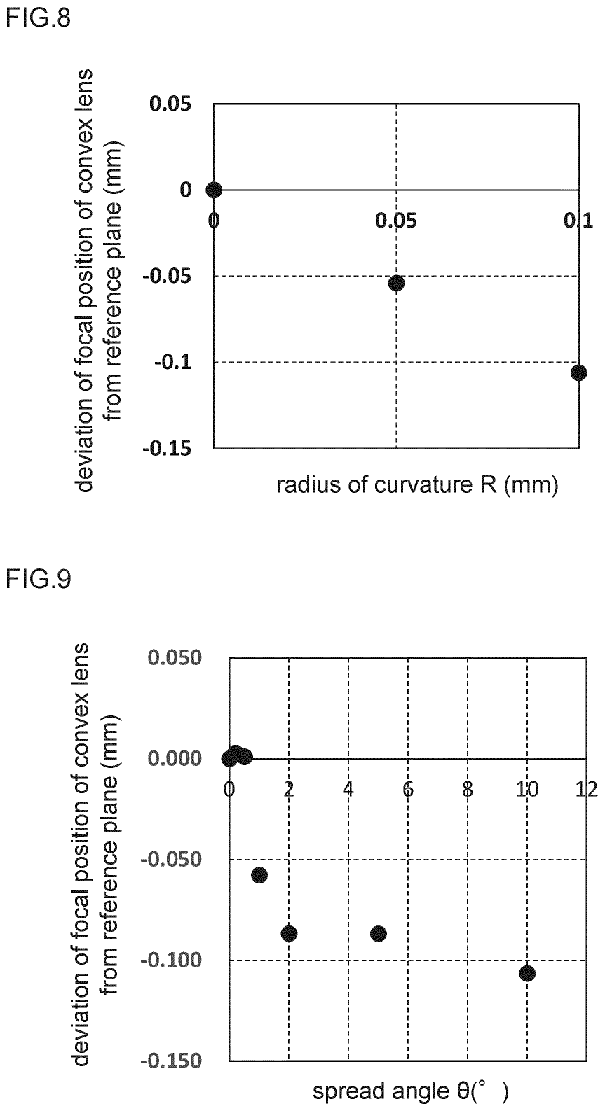

Referring to FIG. 8, a calculation example of the end-capped optical fiber 100C according to the present embodiment will be described. In the calculation example, the wavelength of light propagating through the optical fiber 10 is 459 nm. The refractive index of the first core 10a1 and the second core 10b1 is 1.464904, and the refractive index of the first cladding 10a2 and the second cladding 10b2 is 1.449774. The critical angle θc of the optical fiber 10, which is the maximum propagation angle of light rays that can propagate through the first core 10a1 of the optical fiber 10, is 8.3°. The diameter of the first core 10a1 is 0.11 mm. The refractive index of the end cap 20 is 1.464904. The thickness of the end cap 20 on the optical axis of the convex lens is 23.878 mm. The focal length of the convex lens is 16.3 mm. Zemax OpticStudio was used for the calculations.

FIG. 8 is an example calculation showing the deviation, from the reference plane, of the focal position of the convex lens at which the divergence angle of the light beam L is at minimum for the radius of curvature R. The reference plane is the end face where the optical fiber 10 and the end cap 20 are attached, i.e., the fused surface. In the example shown in FIG. 8, for the sake of discussion, the radius of curvature R=0° represents the case where the core diameter is constant along the optical axis of the core in the optical fiber 10. In the example shown in FIG. 8, the radius of curvature R of the lateral surface, spreading in a curved shape, of the second core 10b1 is 0.05 mm and 0.10 mm.

The horizontal axis shown in FIG. 8 represents the radius of curvature R (mm), and the vertical axis shown in FIG. 8 represents the deviation (mm) of the focal position of the convex lens from the reference plane. The minus sign on the vertical axis means that the position is in the second core 10b1 away from the reference plane. On the horizontal axis, R=0 mm is plotted at the origin. R=0.05 mm and 0.1 mm represent the difference from the origin.

As shown in FIG. 8, there was a trend where the deviation increases as the radius of curvature increases. It is believed that this is because of the fact that as the length of the second portion 10b increases, the pseudo light-emitting surface is positioned away from the end face of the optical fiber 10 to be located inside the optical fiber 10.

Next, referring to FIG. 9, an example calculation of the end-capped optical fiber 100D according to the present embodiment will be described. FIG. 9 is an example calculation showing the deviation, from the reference plane, of the focal position of a convex lens at which the divergence angle of the light beam L is at minimum for the spread angle θ. In the example shown in FIG. 9, for the sake of discussion, the spread angle θ=0(°) represents the case where the core diameter is constant along the optical axis of the core in the optical fiber 10. In the example shown in FIG. 9, the spread angle θ of the lateral surface, spreading linearly, of the second core 10b1 is 0.2°, 0.5°, 1.0°, 2.0°, 5.0°, and 10.0°. The length of the second core 10b1 is fixed at 0.15 mm.

The horizontal axis shown in FIG. 9 represents the spread angle θ (°), and the vertical axis shown in FIG. 9 represents the deviation of the focal position of the convex lens from the reference plane (mm). The minus sign on the vertical axis means that the position is in the second core 10b1 away from the reference plane. On the horizontal axis, θ=0° is plotted at the origin. θ=0.2°, 0.5°, 1.0°, 2.0°, 5.0° and 10.0° represent the difference from the origin.

As shown in FIG. 9, there was a trend where the deviation increases as the spread angle increases. Note that the results at θ=0.2° and 0.5° are almost no difference from the results at θ=0°, and are thought to contain computational errors.

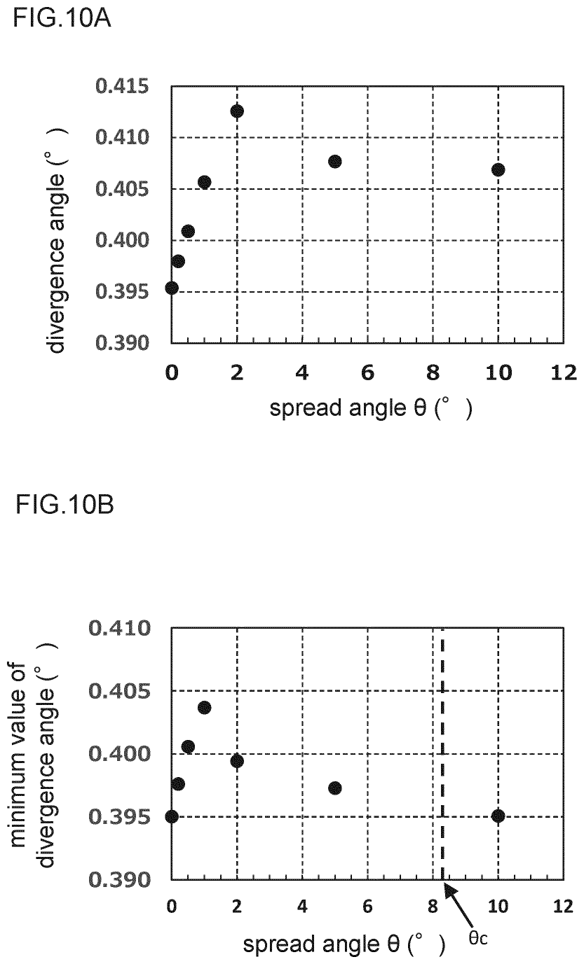

FIG. 10A is a graph showing the relationship between the divergence angle of the light beam L and the spread angle θ of the lateral surface of the second core 10b1 illustrated in FIG. 9 when the focal position of the convex lens coincides with the reference plane. As shown in FIG. 10A, it can be seen that the divergence angle increases when the spread angle θ is larger than 0°.

FIG. 10B is a graph showing the relationship between the minimum value of the divergence angle of the light beam L and the spread angle θ of the lateral surface of the second core 10b1 in the example shown in FIG. 9. As shown in FIG. 10B, as the spread angle θ of the lateral surface of the second core 10b1 increases, the minimum value of the divergence angle of the light beam L increases and then decreases. In FIG. 10B, the position indicated by the bold broken line is the critical angle θc of the optical fiber 10 set in the simulation, which has a value of 8.3°. As shown in FIG. 10B, when the spread angle is greater than 0° and less than θc, the minimum value of the divergence angle is larger than when the spread angle θ is 0°. In contrast, when the spread angle θ is greater than θc, the minimum value of the divergence angle is the same as when the spread angle is 0° and is again the lowest.

These results confirmed that it is preferable to make the spread angle θ larger than the critical angle θc of the optical fiber 10, and to position the focal point F of the convex lens of the end cap 20 inside the optical fiber 10.

In order to qualitatively understand the results of FIG. 8 to FIG. 10B, the behavior of the light beam L will be summarized by dividing it into the following four modes.
(Mode A) spread angle <θc, and focal point F (and focal plane) of convex lens coincides with end face 12 of optical fiber 10
(Mode B) spread angle <θc, and focal point F (and focal plane) of convex lens coincides with boundary between first core 10a1 and second core 10b1
(Mode C) spread angle >θc, and focal point F (and focal plane) of convex lens coincides with end face 12 of optical fiber 10
(Mode D) spread angle >θc, and focal point F (and focal plane) of convex lens coincides with boundary between first core 10a1 and second core 10b1

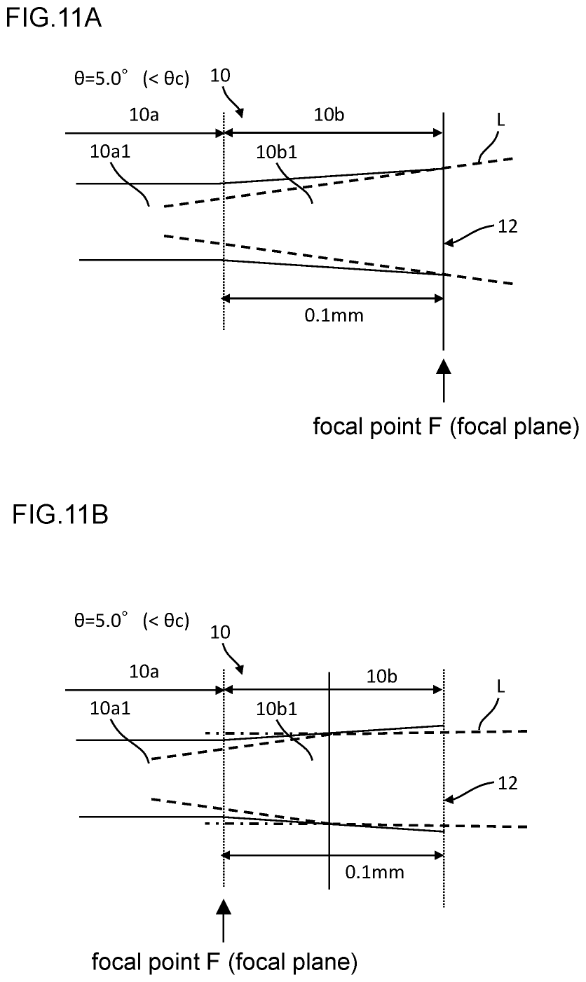

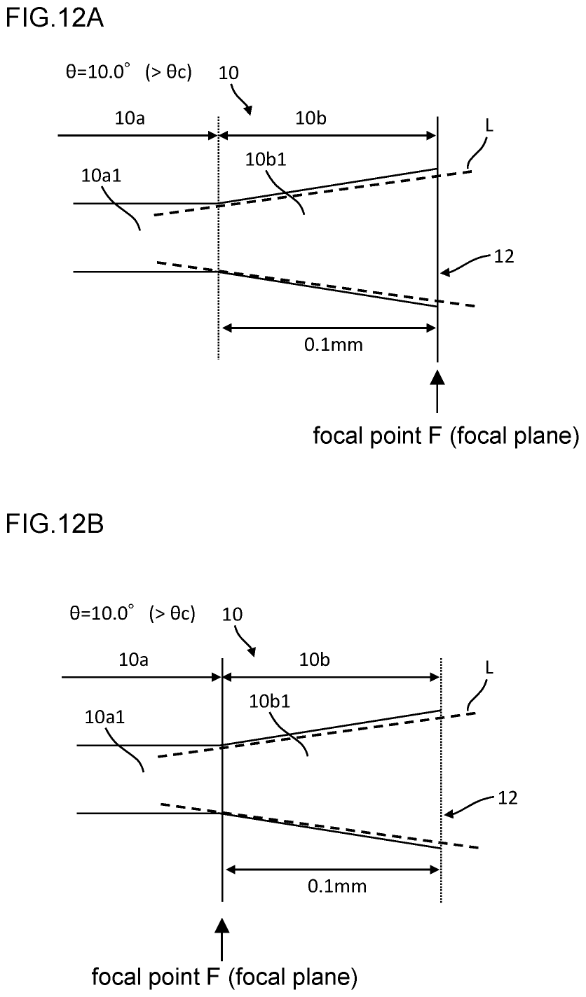

FIG. 11A and FIG. 11B schematically show how light rays propagate through the optical fiber 10 in Mode A and in Mode B, respectively. FIG. 12A and FIG. 12B schematically show how light rays propagate through the optical fiber 10 in Mode C and in Mode D, respectively. In the figures, broken lines represent light rays. θc is the critical angle of the optical fiber 10.

Mode A shown in FIG. 11A is a mode where the spread angle θ of the lateral surface of the second core 10b1 is 5.0° (<θc) and the focal point F of the convex lens coincides with the end face 12 of the optical fiber 10. In Mode A, while the spread angle θ<θc, the light beam L does not reflect on the lateral surface of the second core 10b1 until reaching the end face 12, or the light beam L reflects near the end face 12. In this case, because the light-emitting surface is larger than the cross section of the first core 10a1 (the surface perpendicular to the optical axis), the divergence angle of the light beam L becomes large.

Mode B shown in FIG. 11B is a mode where the spread angle θ of the lateral surface of the second core 10b1 is 5.0° (<θc) and the focal point F of the convex lens coincides with the boundary between the first core 10a1 and the second core 10b1. In mode B, if the light beam L reflects on the lateral surface of the second core 10b1, the pseudo light-emitting surface is the position (solid line) obtained by connecting, with a straight line, between the reflection positions shown in FIG. 11B. In other words, because the pseudo core diameter at the focal position is larger than the size of the first core 10a1 , the pseudo light-emitting surface at the focal position is larger than the cross section of the first core 10a1 . Therefore, the divergence angle of the light beam L becomes large. As shown in FIG. 11B, this can be understood from the fact that if the broken lines are extended toward the boundary line between the first core 10a1 and the second core 10b1 represented by one-dot chain lines, the interval between the two one-dot chain lines is larger than the diameter of the first core 10a1.

Mode C shown in FIG. 12A is a mode where the spread angle θ of the lateral surface of the second core 10b1 is 10.0° (>θc) and the focal point F of the convex lens coincides with the end face 12 of the optical fiber 10. In mode C, the pseudo light-emitting surface is located at the boundary between the first core 10a1 and the second core 10b1. However, because the focal point F does not coincide with the pseudo light-emitting surface, the divergence angle of the light beam L becomes large.

Mode D shown in FIG. 12B is a mode where the spread angle θ of the lateral surface of the second core 10b1 is 10.0° (>θc) and the focal point F of the convex lens coincides with the boundary between the first core 10a1 and the second core 10b1. In mode D, light rays are not reflected on the lateral surface of the second core 10b1 because the spread angle of the lateral surface of the second core 10b1 is larger than the critical angle θc for light rays. Therefore, the light-emitting surface at this boundary is the same as the cross section of the first core 10a1 . Because the light-emitting surface and the focal point F are coincident, the divergence angle is smaller than in Modes A to C.

From the behavior of Mode A to Mode D, it can be seen that Mode B and Mode D can reduce the divergence angle. Mode D is the one that can reduce the divergence angle the most. In other words, it is preferred that the spread angle θ>θc, and the focal point F (and focal plane) of the convex lens coincides with the boundary between the first core 10a1 and the second core 10b1.

When the lateral surface of the second core 10b1 spreads in a curved shape, the spread angle of the lateral surfaces of the second core 10b1 may be read alternatively as the tangent angle of the lateral surface of the second core 10b1. In this case, the tangent angle of the lateral surface of the second core 10b1 is the angle between the tangent line at a certain point on the lateral surface of the second core 10b1 and the optical axis of the second core 10b1. When this point is away from the boundary between the first core 10a1 and the second core 10b1, the tangent angle eventually becomes larger than the critical angle θc. Therefore, a mode where the lateral surface of the second core 10b1 spreads in a curved shape is preferable in that the tangential angle more easily becomes larger than the critical angle θc. The smaller the radius of curvature, the larger the curvature, and thus the tangential angle more easily becomes larger than θc. Therefore, even if the length of the second core 10b1 is relatively short, the tangent angle can easily be larger than the critical angle θc.

The present disclosure includes end-capped optical fibers, fiber arrays, light source devices, and wavelength beam combining devices as set forth in items below.

What is claimed is:

1. An end-capped optical fiber comprising:
an optical fiber comprising:
a first portion comprising a first core, and a first cladding surrounding the first core, and
a second portion comprising a second core, and a second cladding surrounding the second core, the second core being adjacent to the first core, and the second cladding being adjacent to the first cladding; and
a first end cap having a first face and a second face, the first face being connected to an end face of the second portion of the optical fiber, and the second face located on a side opposite the first face; wherein:
a diameter of the first core is constant along an optical axis of the first core;
a diameter of the second core gradually increases toward the first end cap;
the first end cap comprises a convex lens;
the second surface includes a convex lens surface of the convex lens; and
a focal point of the convex lens is located inside the optical fiber and away from the end face of the second portion of the optical fiber.

2. The end-capped optical fiber according to claim 1, wherein the focal point of the convex lens is located inside the second core or at a boundary between the first core and the second core.

3. The end-capped optical fiber according to claim 1, wherein the second core spreads in a curved shape in a plane including an optical axis of the second core.

4. The end-capped optical fiber according to claim 2, wherein the second core spreads in a curved shape in a plane including an optical axis of the second core.

5. The end-capped optical fiber according to claim 1, wherein the second core spreads linearly in a plane including an optical axis of the second core.

6. The end-capped optical fiber according to claim 2, wherein the second core spreads linearly in a plane including an optical axis of the second core.

7. The end-capped optical fiber according to claim 1, wherein an area of the first face of the first end cap is larger than an area of the end face of the second portion of the optical fiber.

8. The end-capped optical fiber according to claim 2, wherein an area of the first face of the first end cap is larger than an area of the end face of the second portion of the optical fiber.

9. The end-capped optical fiber according to claim 3, wherein an area of the first face of the first end cap is larger than an area of the end face of the second portion of the optical fiber.

10. The end-capped optical fiber according to claim 1, wherein the optical fiber is a multi-mode fiber.

11. The end-capped optical fiber according to claim 2, wherein the optical fiber is a multi-mode fiber.

12. The end-capped optical fiber according to claim 1, further comprising:
a second end cap connected to the optical fiber; wherein:
the optical fiber further comprises a third portion located on opposite side of the second portion with respect to the first portion, the third portion comprising a third core and a third cladding surrounding the third core, the third core being adjacent to the first core, and the third cladding being adjacent to the first cladding;
the second end cap has a third face and a fourth face, the third face being connected to an end face of the third portion of the optical fiber, and the fourth face being located on opposite side of the third face;
a diameter of the third core gradually increases toward the second end cap;
the second end cap comprises a second convex lens;
the fourth face includes a convex lens surface of the second convex lens; and
a focal point of the second convex lens is located inside the optical fiber and away from the end face of the third portion of the optical fiber.

13. The end-capped optical fiber according to claim 12, wherein the focal point of the second convex lens is located inside the third core or at a boundary between the first core and the third core.

14. An end-capped optical fiber comprising:
an optical fiber comprising:
a first portion comprising a first core, and a first cladding surrounding the first core, and
a second portion comprising a second core, and a second cladding surrounding the second core, the second core being adjacent to the first core, and the second cladding being adjacent to the first cladding; and
a first end cap having a first face and a second face, the first face being connected to an end face of the second portion of the optical fiber, and the second face being located on opposite side of the first face; wherein:
a diameter of the first core is constant along an optical axis of the first core;
a diameter of the second core gradually increases toward the first end cap;
the first end cap comprises a convex lens;
the second surface includes a convex lens surface of the convex lens; and
a thickness of the first end cap on an optical axis of the convex lens is less than a distance from an apex of the convex lens to a focal point of the convex lens.

15. A fiber array comprising:
a plurality of end-capped optical fibers, each of which is the end-capped optical fiber according to claim 1; wherein:
the second faces of the first end caps of the plurality of end-capped optical fibers are facing the same side.

16. A light source device comprising:
the fiber array according to claim 15, wherein the plurality of end-capped optical fibers comprise a first end-capped optical fiber and a second end-capped optical fiber;
a first laser light source that is configured to emit a first laser beam, the first laser beam coupling to the optical fiber included in the first end-capped optical fiber from a side opposite the first end cap; and
a second laser light source that is configured to emit a second laser beam, the second laser beam coupling to the optical fiber included in the second end-capped optical fiber from a side opposite the first end cap.

17. The light source device according to claim 16, wherein:
the first laser beam has a first peak wavelength;
the second laser beam has a second peak wavelength shorter than the first peak wavelength; and
a thickness of the first end cap included in the second end-capped optical fiber on an optical axis of the convex lens is less than a thickness of the first end cap included in the first end-capped optical fiber on an optical axis of the convex lens.

18. A wavelength beam combining device comprising:
the light source device according to claim 16; and
a diffraction grating; wherein:
the first laser beam has a first peak wavelength;
the second laser beam has a second peak wavelength shorter than the first peak wavelength;
the first end-capped optical fiber configured to emit a first light beam, obtained by collimating the first laser beam, from the second face of the first end cap,
the second end-capped optical fiber configured to emit a second light beam, obtained by collimating the second laser beam, from the second face of the first end cap, and
the diffraction grating is configured to combine a plurality of beams that include the first light beam and the second light beam.
